(19) United States
(12) Patent Application Publication
(10) Pub. No.: US 2014/0136217 A1
(43) Pub. Date: May 15, 2014

(54) BIDDING PROCESS FOR HEALTH CARE SERVICES

(71) Applicant: SCOTT HASTINGS, Show Low, AZ (US)

(72) Inventor: SCOTT HASTINGS, Show Low, AZ (US)

(21) Appl. No.: 13/674,620

(22) Filed: Nov. 12, 2012

(51) Int. Cl. G06Q 50/22

(52) U.S. Cl. 705/2

(57) ABSTRACT

An internet based bidding system for health care services may include an interactive website in communication with a database of health services offered by participating providers. A physician may provide a script bearing a code to a patient so that the patient may request a health care service. The patient may use the code to bid for one of the health care services on the interactive website.

### CROSS REFERENCE TO RELATED APPLICATIONS

This application claims priority to provisional application 61,560,202 filed Nov. 15, 2011.

### BACKGROUND

The present invention relates to bidding processes, and more specifically to bidding processes for health services.

The current system of healthcare systems delivery can be fraught with inefficiencies in providing ancillary healthcare services at an affordable cost. Multiple layers of bureaucracy and bloated health insurance processes may keep free market approaches out of play for a long time.

Therefore, there is a need for a bidding process for health care services according to the present invention.

### SUMMARY

According to one aspect of the invention, an internet based bidding system for health care services, comprises an interactive website having a display wherein the interactive website is in communication with a database of health services offered by participating providers, an asking price linked to each service; a minimum acceptable price linked to each service; and a certificate purchased at the minimum acceptable price that is redeemable for the requested health service.

According to another aspect of the invention, a method of internet based bidding for health care services comprises communicating with a database of the health care services offered by participating providers; displaying an asking price linked to each of the health care services; linking a minimum acceptable price to each of the health care services; selecting a requested one of the health care services; bidding an offered price for the requested health care service; accepting the offered price for the requested health care service; and purchasing a certificate at the accepted price that is redeemable for the requested health service.

As will be explained below, for purposes of this application, the term “script” does not necessarily refer to only a prescription for controlled medication.

### BRIEF DESCRIPTION OF THE DRAWINGS

FIG. 1 illustrates a system for implementing a bidding process for healthcare services according to an exemplary embodiment of the invention;

FIG. 2 is a pictorial flow diagram showing a bidding process for laboratory services according to an exemplary embodiment of the invention of FIG. 1; and

FIG. 3 is a pictorial flow diagram showing a bidding process for radiology services according to an exemplary embodiment of the invention of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method for marketing medical services and products comprising a bargaining process between provider and patient in which the patient presents a coded physician authorization for a service or product at a central website clearinghouse and has the option of bidding the amount he is willing to pay before receiving the service or product.

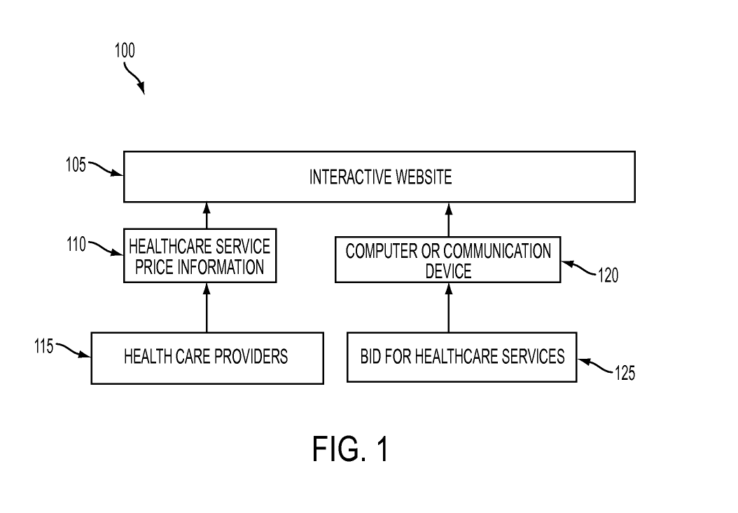

FIG. 1 shows a system 100 for implementing a bidding process for health care services according to an exemplary embodiment of the invention. The system 100 may include an interactive website 105 that may be in communication with a database of health services offered by participating providers. Health care providers 115 may enter health care service price information 110 for the health care services that the health care providers 115 are willing and able to provide. A patient may enter a bidding process 125 for the health care services on the interactive website 105 using a computer or other communication device 120.

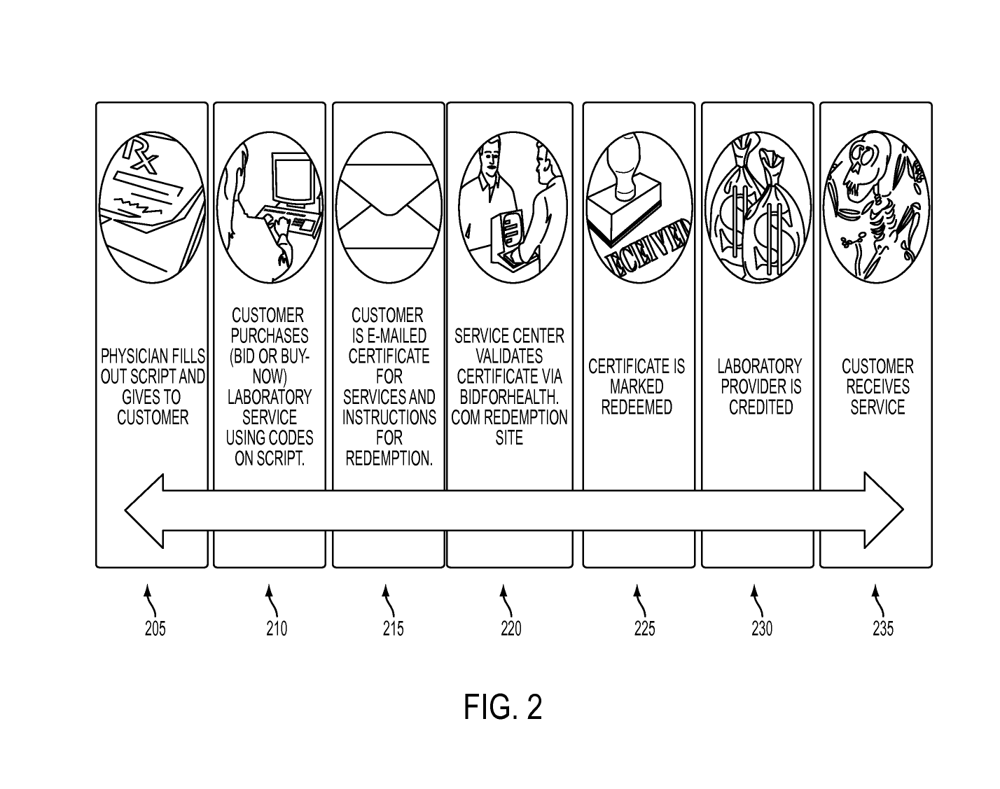

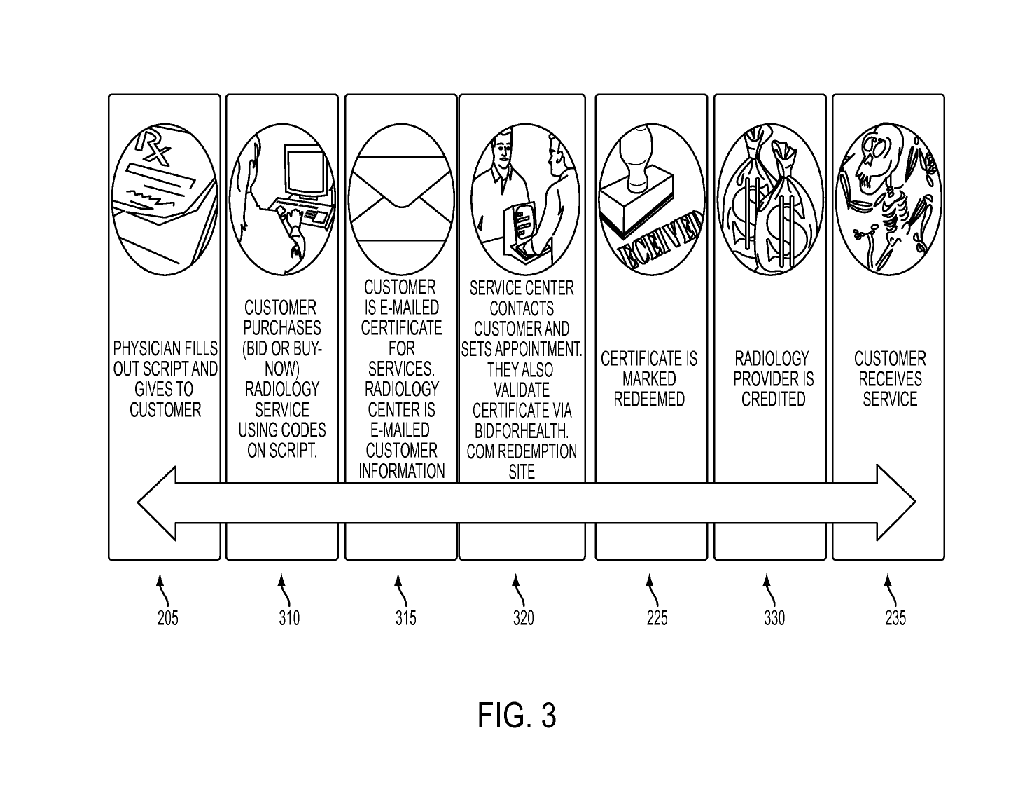

According to an exemplary embodiment of the invention (FIGS. 2 and 3) the process may be initiated when a physician or other health provider writes a script 205 for a patient to receive a medical service or product, as for example, an x-ray procedure, urgent care services, medical supplies, a prescription for a medication or an order for a laboratory test. The written script may be imprinted with a code that can be marked by the provider. The patient can then go to an online redemption website, for example, bidonhealth, where he can enter the marked code for the product and service. There can be a “buy now” asking price listed for the product or service, which can be, for example, about 60% discounted from the average price of each medical service or product. The patient may decide to either buy now 210 at that price or alternatively, to enter a bid for a lower price he is willing to pay for that product or service. For example, the patient may buy a radiology service 310. The patient may not know the minimum acceptable price set by the provider. In the case that his bid may be above the minimum acceptable bid pre-set by the provider, he will be successful and receive a certificate for the service or product.

In an exemplary embodiment, the patient may redeem the certificate by contacting a processing team or a redemption website such as bidonhealth, such that the processing team or redemption website may authorize the procedure or product purchased, and send the patient an authorization code which the patient can take to the provider to acquire a product or service. In the case that his bid may be below the minimum acceptable bid, the patient may not receive a certificate for the service, but may have the opportunity to enter another bid until an agreement is reached. The patient may bid on multiple medical services, for example, radiology, laboratory, and medications, at the same time.

If an agreement can be reached the certificate may be emailed to the patient 215. For example, a certificate for radiology services may be emailed to the patient 315. In a case where a laboratory diagnostic test may be ordered for the patient, a certificate for the test can be automatically emailed with appropriate instructions for receiving the test. A service center at the corporate office or at the provider's site can validate the certificate 220 on the bidonhealth website and the certificate can be marked redeemed. The certificate may be redeemed 225 at the provider's site when the patient may arrive for the test, but can also be redeemed beforehand by the provider because he will have email copies of the voucher. The laboratory provider can be credited 230 and the patient can receive the ordered laboratory test 235.

In a case where the patient may be ordered to receive a service for which he may need an appointment, for example an x-ray examination, the service center or x-ray lab also receives an email notification automatically from the website containing patient information. The service center may then contact the patient to make an appointment 320 for the x-ray and also validate the certificate and authorize crediting the provider. When the patient may show up for his appointment, the radiology provider can be credited 330 for the payment and the patient can receive the service.

The procedure can be used for a variety of health-related services and products, including laboratory services, radiology, medications, dental treatment and the like.

Ancillary medical health providers may have excess time available without paying customers during particular days, hours of a day, or at certain locations. The system of the invention can work by working with healthcare providers to capture off peak times, days and locations with regard to medical services, and re-selling those services to the public through an online bidding process, comprising a “purchase now” option or a “lowest acceptable payment” system. The lower price the provider may be willing to accept from a cash paying customer under such a system can allow the public to purchase these services at a fraction of the customary cash price. Thus, medical service customers may be able to purchase medical goods and services at the same price or lower price than that negotiated by health insurance companies.

The website could also save hours of a patient's time as well as thousands of dollars on everyday healthcare tests and medications by using the negotiating skills of the website operators to find lab and radiology tests by using off-peak hours at labs and radiology centers. The customer may not know where the testing center may be located until after the purchase; however, the savings on the service can offset any inconvenience.

It should be understood, of course, that the foregoing relates to exemplary embodiments of the invention and that modifications may be made without departing from the spirit and scope of the invention as set forth in the following claims.

What is claimed is:

1. An internet based bidding system for health care services, comprising:
an interactive website having a display wherein the interactive website is in communication with a database of health services offered by participating providers;
an asking price linked to each service;
a minimum acceptable price linked to each service; and
a certificate purchased at the minimum acceptable price that is redeemable for a requested health service.

2. The internet based bidding system of claim 1, wherein the requested health service is selected at the interactive website using a code provided to a patient by a physician.

3. The internet based bidding system of claim 1, wherein the database of health services includes prescription medications.

4. The internet based bidding system of claim 1, wherein the database of health services includes medical supplies.

5. The internet based bidding system of claim 1, wherein the database of health services includes urgent care services.

6. A method of internet based bidding for health care services, comprising:
communicating with a database of the health care services offered by participating providers;
displaying an asking price linked to each of the health care services;
linking a minimum acceptable price to each of the health care services;
selecting a requested one of the health care services;
bidding an offered price for the requested health care service;
accepting the offered price for the requested health care service; and
purchasing a certificate at the accepted price that is redeemable for the requested health service.

7. The method of claim 6, wherein the certificate is purchased at the asking price.

8. The method of claim 6, wherein the certificate is purchased at the minimum acceptable price.

9. The method of claim 6, wherein a code taken from a health care prescription is entered at an interactive website to display the requested health care service and the asking price.

10. The method of claim 6, wherein the patient bids on multiple ones of the health care services simultaneously.
